(19) United States
(12) Patent Application Publication
(10) Pub. No.: US 2020/0034847 A1
(43) Pub. Date: Jan. 30, 2020

(54) ARRANGEMENT AND METHOD FOR FACILITATING A TRANSACTION

(71) Applicant: Fingerprint Cards AB, GÖTEBORG (SE)

(72) Inventors: Mats Tuneld, LUND (SE); Olis Olofsson, MALMÖ (SE)

(73) Assignee: Fingerprint Cards AB, GÖTEBORG (SE)

(21) Appl. No.: 16/491,296

(22) PCT Filed: Mar. 8, 2018
(86) PCT No.: PCT/SE2018/050220

§ 371 Date: Sep. 5, 2019

(30) Foreign Application Priority Data
Mar. 9, 2017 (SE) 1750264-2

(51) Int. Cl. G06Q 20/40; G06Q 20/32; G06Q 20/20

(52) U.S. Cl. CPC G06Q 20/40145; G06Q 20/3278; G06Q 20/206; G06Q 20/204; G06Q 20/3223

(57) ABSTRACT

The present disclosure relates to an arrangement and method for facilitating a transaction, specifically combining user input provided to a biometric sensing system and visual identification for advancing the transaction. The present disclosure also relates to an electronic device for use in authenticating of the transaction and to a computer program product for operating an arrangement for facilitating the transaction.

### TECHNICAL FIELD

The present disclosure relates to an arrangement and method for facilitating a transaction, specifically combining user input provided to a biometric sensing system and visual identification for advancing the transaction. The present disclosure also relates to an electronic device for use in authenticating of the transaction and to a computer program product for operating an arrangement for facilitating the transaction.

### BACKGROUND

The use of biometric techniques to identify and/or authenticate the identity of a user is increasing. Biometric techniques that are promoted for this use include voice, fingerprint, iris, vein pattern and other scans. Currently, the use of fingerprint sensors for capturing a fingerprint has shown to be specifically promising, for example due to its ease of integration with different types of electronic equipment, such as smartphones, watches, tablets, or any other type of electronic devices where personalized user interaction is advantageous.

When a “connection” has been formed between the identified/authenticated user and the electronic device, it may be possible to allow the electronic device to be used for further assisting the user in his daily life, such as for personalizing of the user's environment possibly in relation to providing the user with personalized technology offerings.

An example of such a solution is for example presented in U.S. Pat. No. 9,472,033, where a wearable biometric device such as a wristband, wristwatch, bracelet, necklace, ring, comprising a biometric sensor is connected to the user using a pre-authorization process. Once the wearable biometric device has been pre-authorized, the user wearing the wearable biometric device may be identified/authenticated using the wearable biometric device and consequently allowed access to an authorized authentication device (ADD), where the ADD has been previously paired with the wearable biometric device. The ADD may for example be a smartphone, tablet, desktop computer, laptop computer, a terminal, a point-of-sale devices or a network connected personal device. Accordingly, rather than having to enter e.g. a password or a PIN with the ADD, it will be sufficient to place the pre-authorized wearable biometric device worn by the user in proximity with the ADD.

However, even though U.S. Pat. No. 9,472,033 shows an interesting approach to facilitating the daily life for a user by means of a wearable biometric device, the necessity of having to go through a pairing process with the ADD will significantly limit the general use of the proposed technology. Accordingly, there seems to be room for further improvement, specifically as seen from a usability perspective, at the same time taking into account security aspects being apparent in relation to financial transactions.

### SUMMARY

In view of the above-mentioned security problems, it is an object of the present disclosure to provide an improved methodology for performing a transaction, facilitating aspects following when a user is to perform a transaction with a possibly previously unknown party.

According to an aspect of the present disclosure, it is therefore provided an arrangement for facilitating a transaction, the arrangement comprising a portable electronic device associated with a user, comprising a biometric sensing system including a biometric sensor configured to capture biometric data of the user of the portable electronic device, and processing circuitry connected to and configured to control the operation of the biometric sensor, and an electronic transaction terminal, wherein the arrangement is adapted to acquire the biometric data from the biometric sensor arrangement, determine, using the processing circuitry, a biometric matching level by comparing the biometric data and an enrolled biometric representation of the user, authenticate, using the processing circuitry, the user of the portable electronic device if the biometric matching level is above a threshold, establish a wireless connection between the portable electronic device and the electronic transaction terminal, wherein an entity is associated with the electronic transaction terminal, provide user identity related information of the authenticated user to the electronic transaction terminal, perform visual identification of the user of the portable electronic device based on the user identity related information, display entity related information of the entity associated with the electronic transaction terminal to the user of the portable electronic device, perform visual identification of the entity associated with the electronic transaction terminal based on the displayed entity related information, proceed with the transaction if the visual identifications of the user of the portable electronic device and the entity associated with the electronic transaction terminal are successful, wherein the arrangement is further adapted to receive an acceptance from the user before proceeding with the transaction, and the acceptance is received from the user using the biometric sensor comprised with the portable electronic device.

By means of the present disclosure, it is possible to improve how a user (e.g. receiving/purchasing a product or service) may interact with an entity (e.g. providing/selling the product or service), with the purpose of facilitating a transaction between the user and the entity. In accordance therewith, a further element for facilitating the interaction between the user and the entity is provided, comprising performing a visual identification of the respective parties (i.e. the user and the entity), at least based on user identity related information of the user that has been provided to the entity. In a possible embodiment of the disclosure the user is a buyer of the product or service, and the entity is a vendor of the product or service.

To exemplify, user identity related information will be provided from a portable electronic device associated with the user to an electronic transaction terminal associated with the entity. Once received at the electronic transaction terminal, a visual identification will be performed, possibly manually by the entity or using an at least partly automated process performed by the electronic transaction terminal. As an example, the user identity related information of the authenticated user may comprise an image of the user of the portable electronic device, for example stored at the portable electronic device.

Additionally, some form of entity related information will be displayed to the user, thus also allowing the user to visually identify the entity. A level of trust may thus be formed between the user and the entity such that the transaction may be advanced forward. The display of the entity related information may in some embodiments be provided using the user's portable electronic device or using a display related to the electronic transaction terminal.

It should, in accordance to the present disclosure, be understood that the user identity related information provided from the portable electronic device to the electronic transaction terminal will include an indication that the user identity related information provided by the portable electronic device has a trusted relation to the user, including that a biometric relation has been formed between the user and the portable electronic device. Thus, once the user identity related information is received at the electronic transaction terminal it may, at a high reliability level, be assured that the visual identification may be performed on trustworthy user identity related information relating to the user. The electronic transaction terminal may for example be a point-of-sale (POS) related electronic transaction terminal.

In line with the above discussion, it desirable that the entity related information comprises an identity of the entity and information related to the transaction. Accordingly, the identity of the entity may for example be shown to the user by means of the above-mentioned display. The user may thereby subsequently acknowledge that the identity for the entity is as expected for the present transaction process, before the transaction is to be performed.

Once the transaction is accepted by the user and the entity, the transaction may be advanced further. As such, the arrangement may be adapted to further comprise a payment server, wherein the payment server is configured to perform the transaction once authenticated.

In an embodiment of the present disclosure it is desirable to allow the user to also “sign” the transaction, to ensure that the user in fact has fully accepted e.g. the purchase process. This will of course further strengthen the trust between the user and the entity, as well as ensuring that there is non-repudiation involved with the transaction. In a possible embodiment the user acceptance is provided by the user using the biometric sensor.

Preferably, the biometric sensor is a fingerprint sensor comprised with the portable electronic device, the fingerprint sensor for example having an array of pixels and configured for capturing fingerprint data comprising a representation of a fingerprint pattern of a finger of the user. It should be understood that the fingerprint sensor preferably is a fingerprint touch sensor; however the disclosure may also be implemented using e.g. a swipe fingerprint sensor. The fingerprint sensor may be implemented using any kind of current or future fingerprint sensing principle, including for example capacitive, optical, or thermal sensing technology. However, at present capacitive sensing is most preferred. Both one and two-dimensional sensors are possible and within the scope of the present disclosure.

Within the context of the present disclosure, the expression “fingerprint data” should be interpreted broadly and to include both a regular “visual image” of a fingerprint of a finger as well as a set of measurements relating to the finger when acquired using the fingerprint sensor. A plurality of fingerprint images may be subsequently acquired and fused together, where the resulting information is used as an input for determining sets of fingerprint features.

Alternatively, or also, the biometric sensor may be a motion sensor configured to capture a motion of the portable electronic device in space. Still further, the biometric sensor may include a camera configured to capture an image of the user. Such a camera may also be used for e.g. capturing a pulse pattern for the user, an iris or a retina of the user, etc. It is worth noticing that the biometric sensing system as presented above may include more than a single biometric sensor, such as for example a combination of a fingerprint sensor together with a motion sensor and/or a camera.

Accordingly, in an embodiment of the present disclosure the user will, by means of the biometric sensor, form an authenticated relation between himself and the portable electronic device. The biometric sensor may then, in the possible embodiment as exemplified above, be used also for providing user acceptance for proceeding with the transaction.

In an embodiment of the present disclosure, the portable electronic device may be at least one of a wearable electronic device and a mobile phone. Such a wearable device may for example be a smart watch, a ring, a bracelet, etc.

Furthermore and in line with the above discussion, the expression “processing circuitry” as used above should be understood to include any type of computing device, such as an ASIC, a micro-processor, etc. It should also be understood that the actual implementation of such a processing circuitry may be divided between more than a single device/circuit.

Alternatively, or also, the portable electronic device may further comprises a first display unit connected to the processing circuitry, wherein the first display unit is adapted to display the entity related information of the entity associated with the electronic transaction terminal. Similarly, the electronic transaction terminal may further comprise a second display unit, wherein the second display unit is adapted to display the user identity related information of the authenticated user. As such, the buyer and the vendor may perform a visual conformation of the respective party using “his own” electronic equipment.

In some embodiments the portable electronic device may lack displaying functionality, such as the first display unit. In such a case the second display unit provided at the electronic transaction terminal may be used for displaying the entity related information of the entity associated with the electronic transaction terminal.

According to another aspect of the present disclosure, there is provided an arrangement for facilitating a transaction, the arrangement comprising a portable electronic device associated with a user, comprising a biometric sensing system including a biometric sensor configured to capture biometric data of the user of the portable electronic device, and processing circuitry connected to and configured to control the operation of the biometric sensor, and an electronic transaction terminal, wherein the arrangement is adapted to acquire the biometric data from the biometric sensor arrangement, determine, using the processing circuitry, a biometric matching level by comparing the biometric data and an enrolled biometric representation of the user, authenticate, using the processing circuitry, the user of the portable electronic device if the biometric matching level is above a threshold, establish a wireless connection between the portable electronic device and the electronic transaction terminal, wherein an entity is associated with the electronic transaction terminal, provide user identity related information of the authenticated user to the electronic transaction terminal, perform visual identification of the user of the portable electronic device based on the user identity related information, display entity related information of the entity associated with the electronic transaction terminal to the user of the portable electronic device, perform visual identification of the entity associated with the electronic transaction terminal based on the displayed entity related information, proceed with the transaction if the visual identifications of the user of the portable electronic device and the entity associated with the electronic transaction terminal are successful, wherein the electronic transaction terminal comprises a control unit and camera configured to capture an image of the user, the control unit adapted to automatically perform the visual identification of the user of the portable electronic device, wherein the visual identification is based on a comparison between the user identity related information and the image of the user captured by the camera.

Accordingly, the electronic transaction terminal may in this alternative aspect of the present disclosure be arranged to comprises a control unit and camera configured to capture an image of the user, the control unit adapted to at least partly automatically perform the visual identification of the user of the portable electronic device, wherein the visual identification is based on a comparison between the user identity related information and the image of the user captured by the camera. Thus, in some embodiments the entity is not a person but rather “a machine” providing the product or service. An example of such a scenario may for example relate to a partly automated process for issuing a bus or a train ticket, where the visual identification is to be performed automatically by the electronic transaction terminal rather than by a person operating the electronic transaction terminal.

According to another aspect of the present disclosure, there is provided a portable electronic device adapted to facilitate a transaction, the portable electronic device comprising a biometric sensing system including a biometric sensor configured to capture biometric data of the user of the portable electronic device, and processing circuitry connected to and configured to control the operation of the biometric sensor, and wherein the portable electronic arrangement is configured to acquire the biometric data from the biometric sensor arrangement, determine, using the processing circuitry, a biometric matching level by comparing the biometric data and an enrolled biometric representation of the user, authenticate, using the processing circuitry, the user of the portable electronic device if the biometric matching level is above a threshold, establish a wireless connection between the portable electronic device and an electronic transaction terminal, wherein an entity is associated with the electronic transaction terminal, provide user identity related information of the authenticated user to the electronic transaction terminal, and proceed with the transaction if the entity associated with the electronic transaction terminal is successfully visually identified, wherein the portable electronic arrangement is further adapted to receive an acceptance from the user before proceeding with the transaction, and the acceptance is received from the user using the biometric sensor comprised with the portable electronic device. This aspect of the present disclosure provides similar advantages as discussed above in relation to the previous aspect of the present disclosure.

In accordance to a still further aspect of the present disclosure there is provided a method of facilitating a transaction using a portable electronic device associated with a user, the portable electronic device comprising a biometric sensing system including a biometric sensor configured to capture biometric data of the user of the portable electronic device, and processing circuitry connected to and configured to control the operation of the biometric sensor, the method comprising the steps of acquiring the biometric data from the biometric sensor arrangement, determining, using the processing circuitry, a biometric matching level by comparing the biometric data and an enrolled biometric representation of the user, authenticating, using the processing circuitry, the user of the portable electronic device if the biometric matching level is above a threshold, establishing a wireless connection between the portable electronic device and an electronic transaction terminal, wherein an entity is associated with the electronic transaction terminal, providing user identity related information of the authenticated user to the electronic transaction terminal, performing visual identification of the user of the portable electronic device based on the user identity related information, displaying entity related information of the entity associated with the electronic transaction terminal to the user of the portable electronic device, performing visual identification of the entity associated with the electronic transaction terminal based on the displayed entity related information, proceed with the transaction if the visual identifications of the user of the portable electronic device and the entity associated with the electronic transaction terminal are successful, wherein the computer program product comprises further comprises code for receiving an acceptance from the user before proceeding with the transaction, and the acceptance is received from the user using the biometric sensor comprised with the portable electronic device. Also this aspect of the present disclosure provides similar advantages as discussed above in relation to the previous aspects of the present disclosure.

Furthermore, in accordance to an aspect of the present disclosure there is provided a computer program product comprising a non-transitory computer readable medium having stored thereon computer program means for operating an arrangement for facilitating a transaction, the arrangement comprising a portable electronic device associated with a user, comprising a biometric sensing system including a biometric sensor configured to capture biometric data of the user of the portable electronic device, and processing circuitry connected to and configured to control the operation of the biometric sensor, and an electronic transaction terminal, wherein the computer program product comprises code for acquiring the biometric data from the biometric sensor arrangement, code for determining, using the processing circuitry, a biometric matching level by comparing the biometric data and an enrolled biometric representation of the user, code for authenticating, using the processing circuitry, the user of the portable electronic device if the biometric matching level is above a threshold, code for establishing a wireless connection between the portable electronic device and an electronic transaction terminal, wherein an entity is associated with the electronic transaction terminal, code for providing user identity related information of the authenticated user to the electronic transaction terminal, code for performing visual identification of the user of the portable electronic device based on the user identity related information, code for displaying entity related information of the entity associated with the electronic transaction terminal to the user of the portable electronic device, code for performing visual identification of the entity associated with the electronic transaction terminal based on the displayed entity related information, code for proceeding with the transaction if the visual identifications of the user of the portable electronic device and the entity associated with the electronic transaction terminal are successful. Also this aspect of the present disclosure provides similar advantages as discussed above in relation to the previous aspects of the present disclosure.

In summary, the present disclosure relates to an arrangement and method for facilitating a transaction, specifically combining user input to a biometric sensing system and visual identification for authenticating the transaction. The present disclosure also relates to an electronic device for use in authenticating of the transaction and to a computer program product for operating an arrangement for facilitating the transaction. The present disclosure provides a solution that may improve a level of trust between a buyer and a vendor by sharing visually verifiable and trustworthy information there between.

Further features of, and advantages with, the present disclosure will become apparent when studying the appended claims and the following description. The skilled addressee realize that different features of the present disclosure may be combined to create embodiments other than those described in the following, without departing from the scope of the present disclosure.

### BRIEF DESCRIPTION OF THE DRAWINGS

The various aspects of the present disclosure, including its particular features and advantages, will be readily understood from the following detailed description and the accompanying drawings, in which:

FIG. 1 conceptually illustrates an arrangement for handling a portion of a transaction presented in accordance to a currently preferred embodiment of the present disclosure;

FIGS. 2A, 2B and 2C illustrate examples of portable electronic devices for use with the arrangement as shown in FIG. 1;

FIG. 4 shows an exemplary operation of the arrangement as shown in FIG. 1;

FIG. 5 is a flowchart illustrating the exemplary steps of the present disclosure for facilitating a transaction between a user and an entity

FIGS. 6A and 6B show alternative actions for providing a user acceptance, and

FIG. 7 shows an alternative operation of the arrangement as shown in FIG. 1.

### DETAILED DESCRIPTION

The present disclosure will now be described more fully hereinafter with reference to the accompanying drawings, in which currently preferred embodiments of the present disclosure are shown. This present disclosure may, however, be embodied in many different forms and should not be construed as limited to the embodiments set forth herein; rather, these embodiments are provided for thoroughness and completeness, and fully convey the scope of the present disclosure to the skilled person. Like reference characters refer to like elements throughout.

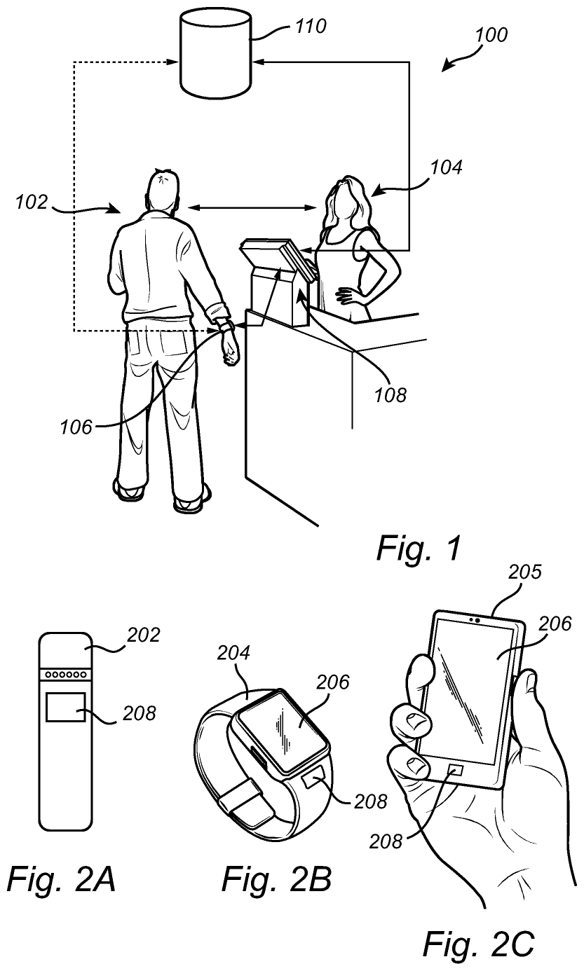

Turning now to the drawings and to FIGS. 1, 2A, 2B and 2C in particular, there is schematically illustrated an arrangement 100 for handling a portion of a transaction between a user 102 and an entity 104. In the illustrated embodiment the user 102 will be exemplified as a “buyer” and the entity 104 will be exemplified as a “vendor”. In accordance to the present disclosure, the user/buyer 102 is provided with a portable electronic device 106, for example being a wearable electronic device such an electronic bracelet 202, a smart watch 204 or a mobile phone 205, etc. In a possible embodiment of the present disclosure the smart watch 204 comprises a display unit 206 with a touch screen interface. The portable electronic device 106 must however not necessarily comprise a display unit. In some embodiments, such as in relation to the bracelet 202, the bracelet 202 may in some embodiment completely lack means for providing feedback to the user. However, it may be possible (also in relation to the smart watch 204 or mobile phone 205) to include means for providing the user with haptic feedback, or to include e.g. one or a plurality of light sources for providing user feedback.

It should furthermore be noted that the present disclosure may be applicable in relation to any other type of portable electronic device 106, for example a necklace or a ring.

In accordance to the illustrated embodiment, the arrangement 100 further comprises an electronic transaction terminal 108 being associated with the entity/vendor 104. The electronic transaction terminal 108 may for example be a POS terminal as has been indicated above and will be further elaborated below. The portable electronic device 106 and the electronic transaction terminal 108 are adapted to allowing wireless communication there-between, such as by means of each integrating a wireless transceiver (not explicitly shown). The wireless transceivers may for example be adapted for Bluetooth, WLAN/WiFi, NFC, ZigBee, etc., communication.

The arrangement 100 may in some embodiments further comprise a payment server 110, for example adapted for assisting with the transfer of e.g. monetary funds from the buyer 102 to the vendor 104. The payment server 110 should however be understood to be an optional component of the arrangement 100, since the service of e.g. transfer of monetary funds is some embodiments may be handled by a bank or similar. Thus, e.g. the electronic transaction terminal 108 (and possibly also the portable electronic device 106) may be adapted to communicate directly with e.g. the bank.

In accordance to the present disclosure, the portable electronic device 106 is provided with a biometric sensing system including a biometric sensor configured to capture biometric data of the user 102. The biometric sensor may for example be a fingerprint sensor 208, a camera, a motion sensor, etc., that has been provided in relation to the portable electronic device 106. In a typical embodiment the biometric sensor is integrated with the portable electronic device 106.

The portable electronic device 106 preferably also comprises a processing circuitry (not shown) connected to and configured to control the operation of the biometric sensor, for example for acquire biometric data from the biometric sensor and to authenticate the user 102 based on the acquired biometric data. The processing circuitry may further comprise a memory, such as a database, e.g. for storing biometric template information for the user. The processing circuitry may each include a microprocessor, microcontroller, programmable digital signal processor or another programmable device. The processing circuitry may also, or instead, each including an application specific integrated circuit, a programmable gate array or programmable array logic, a programmable logic device, or a digital signal processor. Where the processing circuitry includes a programmable device such as the microprocessor, microcontroller or programmable digital signal processor mentioned above, the processor may further include computer executable code that controls operation of the programmable device.

As indicated above, the biometric sensor may for example be a fingerprint sensor 208. With further reference to FIG. 3, there is conceptually illustrated a somewhat enlarged view of the fingerprint sensor 208. In the case of employing a capacitive sensing technology, the fingerprint sensor 208 is configured to comprise a large plurality of sensing elements, preferably arranged as a two-dimensional array. The two-dimensional array may have sizes depending on the planned implementation and in an embodiment 160×160 pixels are used. Other sizes are of course possible and within the scope of the present disclosure, including two-dimensional array with less pixels as compared to the above example. A single sensing element (also denoted as a pixel) is in FIG. 3 indicated by reference numeral 302.

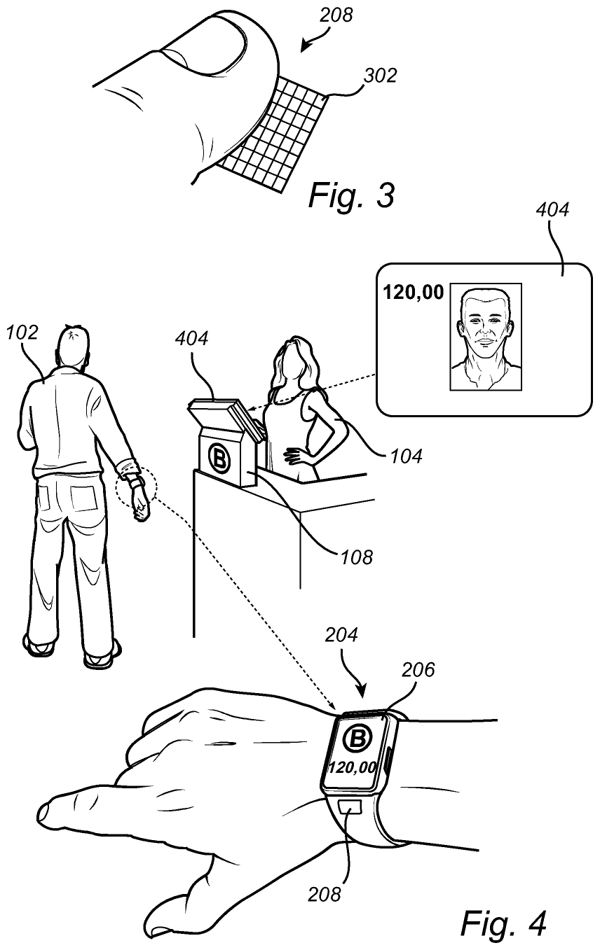

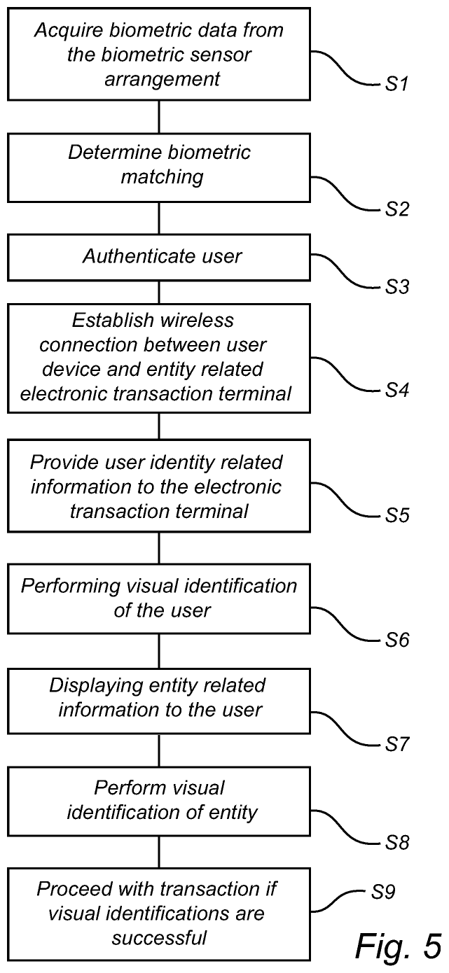

Turning now to FIGS. 4 and 5, showing a first exemplary operation of the arrangement 100. In the present illustration the buyer 102 is wearing a smart watch 204. The vendor 104 is in turn a “person”, such as a sales person within e.g. a shop. The vendor 104 is provided with the above mentioned electronic transaction terminal 108, specifically being a POS terminal provided with a display unit 404.

In accordance to the present disclosure, the user/buyer 102 is at least at some point in time arranged to form a “connection” to the portable electronic device 106, such as the smart watch 204. The formation of the connection is achieved by acquiring, S1, biometric data relating to the user by means of the biometric sensor, such as using the fingerprint sensor 208 comprised with the smart watch 204, where the fingerprint sensor 208 is adapted to acquire a representation of a fingerprint of the user 102.

The processing circuitry will subsequently determine, S2, a biometric matching level between the acquired fingerprint of the user 102 and a biometric template relating to the user 102. When the biometric sensor is the fingerprint sensor 208, the biometric template may be a fingerprint template representing a previously enrolled fingerprint for a finger of the user. The processing circuitry will further authenticate, S3, the user based on the matching level.

As indicated above, a wireless connection is to be established, S4, between the portable electronic device 106, e.g. the smart watch 204, and the electronic transaction terminal 108, e.g. the POS terminal. Once the wireless connection has been established, it is possible allow the smart watch 204 and the POS terminal to share information there-between. Specifically, in accordance to the present invention the smart watch 204 is adapted to provide, S5, user identity related information of the authenticated user 102 to the POS terminal. The user identity related information may in one embodiment of the present invention include a photo of the user/buyer 102, for example showing at least a portion of the user's face. The photo of the user may for example be presented on the display unit 404 comprised with the POS terminal 402. Thereby, the sales person operating the POS terminal may for example be instructed to perform, S6, a visual identification of the user/buyer 102.

In a similar manner, information relating to the entity 104 being associated with the electronic transaction terminal 108, such as information about the vendor operating the POS terminal, is provided to the user. Specifically, the entity related information is displayed, S7, to the user 102, for example using the display unit 206 comprised with the smart watch 204, or using the display unit 404 comprised with the POS terminal in case the portable electronic device 106 lacks means for displaying the entity related information. The entity related information may in some embodiments be a photo of the sales person. However, in some alternative embodiments it may be more appropriate to display some other form of graphical information relating to the entity, such as a logo relating to the entity. The user will accordingly perform, S8, visual identification of e.g. the sales person based on the displayed entity related information.

Following a mutual visual identification of the respective parties the arrangement may proceed, S9, with the transaction between the buyer 102 and the vendor 104. This may in some embodiments include initiating the transaction of monetary funds between the buyer 102 and the vendor 104, for example using the payment server 110 in case the buyer 102 had the purpose of purchasing a product or service from the vendor 104.

Alternatively an instruction may be provided, to e.g. a bank though a suitable interface, for initiating the transfer. Generally it should however be understood that proceeding with the transaction must not necessarily including e.g. transfer of monetary funds. Rather, the transaction may relate to providing a signature of e.g. a document or file, to ensure non-repudiation of an agreement between the user 102 and the entity 104, etc.

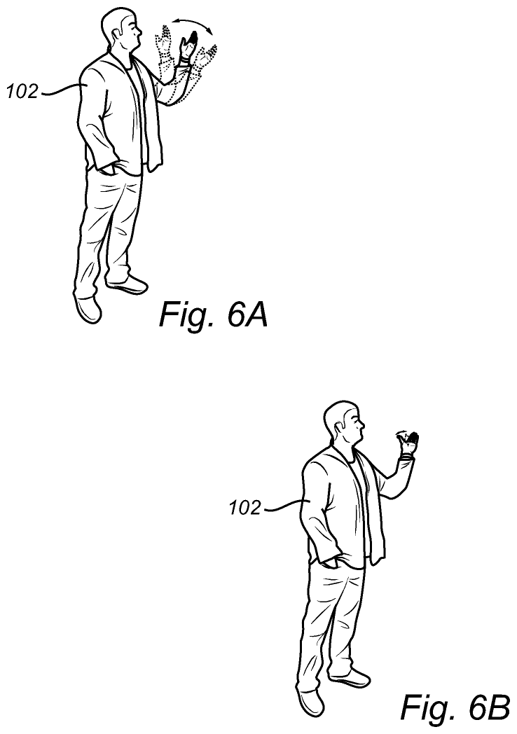

In some embodiments of the present disclosure, with further reference to FIGS. 6A and 6B, it may be possible to further include the step of receiving an (additional) acceptance from the user 102 before proceeding with the transaction. Such an acceptance may for example be received at the portable electronic device 106, e.g. the smart watch 204, using the biometric sensor. In FIG. 6A there is provided a first example where the smart watch 204 has been adapted to (additionally) comprise a motion sensor configured to capture a motion of the portable electronic device in space. The user acceptance may in such an embodiment include capturing how the user is moving his arm in line with a predetermined movement pattern. If the arm movement performed by the user 102 corresponds to the predetermined, and previously enrolled, movement pattern this may be interpreted as the user acceptance. Alternatively, with reference to FIG. 6B, a movement pattern performed using the users fingers, e.g. a finger gesture, may in a similar manner be used for determining the mentioned user acceptance.

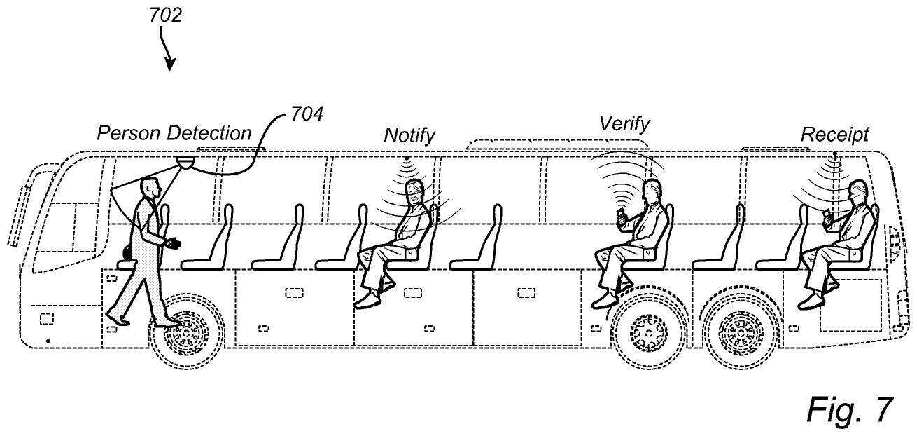

Turning finally to FIG. 7 showing an alternative operation of the arrangement 100 as shown in FIG. 1. In comparison to the embodiment shown in FIG. 4, the entity is in this embodiment not a person by rather an organization associated with the electronic transaction terminal 108. Specifically, in FIG. 7 the electronic transaction terminal 108 is provided on a public bus 702 and the entity is the organization providing the service of operating the bus 702.

In accordance to the embodiment as shown in FIG. 7, the user 102 will enter the bus 702. The user is wearing his portable electronic device 106 and may have been previously authenticated in a similar manner to what has been disclosed above. The portable electronic device 106 will in this specific embodiment establish the wireless connection with the electronic transaction terminal 108 provided with the bus 702 and the user identity related information, for example comprising a photo of the user 102, to the electronic transaction terminal 108. The bus 702 will in this embodiment comprise a camera 704, typically in communication with the electronic transaction terminal 108. The electronic transaction terminal 108 will accordingly collect an image of the user 102 and compare this image with the photo of the user 102 received from the portable electronic device 106. If there is a match there between, the visual identification of the user 102 has been performed.

The user 102 on the other hand will be provided with entity related information, for example displayed at the display unit 206 comprised with the smart watch 204. Alternatively, the entity related information may be displayed at a display unit (not shown) comprised with the electronic transaction terminal 108 provided with the bus 702.

In the present embodiment the transaction will relate to the purchase of a bus ticked for the user 102. Accordingly, once the visual identification of the user 102 as well as the visual identification of the entity is considered to have been successful, the transaction may be proceeded and the entity may issue a bus ticket for the user 102. In a corresponding manner a sufficient monetary fund may be transferred from the user 102 to the entity 104, i.e. the bus organization.

As has been discussed above, the user 102 may optionally be required to provide his acceptance of purchasing the bus ticket. The acceptance may for example be provided using the biometric sensor, e.g. the fingerprint sensor, the motion sensor, or a camera, etc.

The embodiment as shown in FIG. 7 may be initiated automatically as soon as the user 102 enters the bus 702. Accordingly, the steps as defined in accordance to the present disclosure must not necessarily be performed in the listed order (such as S1-S9), rather the steps may be performed partly in parallel or in different orders and dependent on a previously performed step. For example, the user may be “pre-authenticated” (e.g. S1-S3) already when the user “puts on the smart watch 204” in the morning, where after the following steps may be performed at a later stage. In addition, the user may in some embodiments have access to e.g. a first and a second portable electronic device, where some steps are performed using the first portable electronic device and some (further) steps are performed using the second portable electronic device.

The control functionality of the present disclosure may be implemented using existing computer processors, or by a special purpose computer processor for an appropriate system, incorporated for this or another purpose, or by a hardwire system. Embodiments within the scope of the present disclosure include program products comprising machine-readable medium for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a sequence the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps. Additionally, even though the present disclosure has been described with reference to specific exemplifying embodiments thereof, many different alterations, modifications and the like will become apparent for those skilled in the art.

In addition, variations to the disclosed embodiments can be understood and effected by the skilled addressee in practicing the present disclosure, from a study of the drawings, the disclosure, and the appended claims. Furthermore, in the claims, the word “comprising” does not exclude other elements or steps, and the indefinite article “a” or “an” does not exclude a plurality.

1. An arrangement for facilitating a transaction, the arrangement comprising:
a portable electronic device associated with a user, comprising:
a biometric sensing system including a biometric sensor configured to capture biometric data of the user of the portable electronic device, and
processing circuitry connected to and configured to control the operation of the biometric sensor, and
an electronic transaction terminal,
wherein the arrangement is adapted to:
acquire the biometric data from the biometric sensor arrangement;
determine, using the processing circuitry, a biometric matching level by comparing the biometric data and an enrolled biometric representation of the user;
authenticate, using the processing circuitry, the user of the portable electronic device if the biometric matching level is above a threshold;
establish a wireless connection between the portable electronic device and the electronic transaction terminal, wherein an entity is associated with the electronic transaction terminal;
provide user identity related information of the authenticated user to the electronic transaction terminal;
perform visual identification of the user of the portable electronic device based on the user identity related information;
display entity related information of the entity associated with the electronic transaction terminal to the user of the portable electronic device;
perform visual identification of the entity associated with the electronic transaction terminal based on the displayed entity related information;
proceed with the transaction if the visual identifications of the user of the portable electronic device and the entity associated with the electronic transaction terminal are successful,
wherein the arrangement is further adapted to receive an acceptance from the user before proceeding with the transaction, and the acceptance is received from the user using the biometric sensor comprised with the portable electronic device.

2. The arrangement according to claim 1, wherein the entity related information comprises an identity of the entity and information related to the transaction.

3. The arrangement according to claim 1, wherein the biometric sensor is a fingerprint sensor and configured for capturing a fingerprint representation of a fingerprint pattern of a finger of the user.

4. The arrangement according to claim 1, wherein the biometric sensor is a motion sensor configured to capture a motion of the portable electronic device in space.

5. The arrangement according to claim 1, wherein the biometric sensor is a camera configured to capture an image of the user.

6. The arrangement according to claim 1, wherein the user identity related information of the authenticated user comprises an image of the user of the portable electronic device.

7. The arrangement according to claim 6, wherein the image of the user is stored at the portable electronic device.

8. The arrangement according to claim 1, wherein the portable electronic device is at least one of a wearable electronic device and a mobile phone.

9. The arrangement according to claim 8, wherein the wearable device is a smart watch.

10. The arrangement according to claim 1, wherein the portable electronic device further comprises a first display unit connected to the processing circuitry, wherein the first display unit is adapted to display the entity related information of the entity associated with the electronic transaction terminal.

11. The arrangement according to claim 1, wherein the electronic transaction terminal further comprises a second display unit, wherein the second display unit is adapted to display at least one of the user identity related information of the authenticated user and the entity related information of the entity associated with the electronic transaction terminal.

12. The arrangement according to claim 1, further comprising a payment server, wherein the payment server is configured to perform the transaction once authenticated.

13. An arrangement for facilitating a transaction, the arrangement comprising:
a portable electronic device associated with a user, comprising:
a biometric sensing system including a biometric sensor configured to capture biometric data of the user of the portable electronic device, and
processing circuitry connected to and configured to control the operation of the biometric sensor, and
an electronic transaction terminal,
wherein the arrangement is adapted to:
acquire the biometric data from the biometric sensor arrangement;
determine, using the processing circuitry, a biometric matching level by comparing the biometric data and an enrolled biometric representation of the user;
authenticate, using the processing circuitry, the user of the portable electronic device if the biometric matching level is above a threshold;
establish a wireless connection between the portable electronic device and the electronic transaction terminal, wherein an entity is associated with the electronic transaction terminal;
provide user identity related information of the authenticated user to the electronic transaction terminal;
perform visual identification of the user of the portable electronic device based on the user identity related information;
display entity related information of the entity associated with the electronic transaction terminal to the user of the portable electronic device;
perform visual identification of the entity associated with the electronic transaction terminal based on the displayed entity related information;
proceed with the transaction if the visual identifications of the user of the portable electronic device and the entity associated with the electronic transaction terminal are successful,
wherein the electronic transaction terminal comprises a control unit and camera configured to capture an image of the user, the control unit adapted to automatically perform the visual identification of the user of the portable electronic device, wherein the visual identification is based on a comparison between the user identity related information and the image of the user captured by the camera.

14. (canceled)

15. A method of facilitating a transaction using a portable electronic device associated with a user, the portable electronic device comprising a biometric sensing system including a biometric sensor configured to capture biometric data of the user of the portable electronic device, and processing circuitry connected to and configured to control the operation of the biometric sensor, the method comprising:
acquiring the biometric data from the biometric sensor arrangement;
determining, using the processing circuitry, a biometric matching level by comparing the biometric data and an enrolled biometric representation of the user;
authenticating, using the processing circuitry, the user of the portable electronic device if the biometric matching level is above a threshold;
establishing a wireless connection between the portable electronic device and an electronic transaction terminal, wherein an entity is associated with the electronic transaction terminal;
providing user identity related information of the authenticated user to the electronic transaction terminal;
performing visual identification of the user of the portable electronic device based on the user identity related information;
displaying entity related information of the entity associated with the electronic transaction terminal to the user of the portable electronic device;
performing visual identification of the entity associated with the electronic transaction terminal based on the displayed entity related information;
proceeding with the transaction if the visual identifications of the user of the portable electronic device and the entity associated with the electronic transaction terminal are successful,
wherein the method further comprises receiving an acceptance from the user before proceeding with the transaction, and the acceptance is received from the user using the biometric sensor comprised with the portable electronic device.

16. (canceled)
